(19) United States
(12) Patent Application Publication
(10) Pub. No.: US 2018/0368340 A1
(43) Pub. Date: Dec. 27, 2018

(54) IRRIGATION SYSTEM WITH AUTOMATIC IRRIGATION LIQUID SPRAYING DEVICE

(71) Applicant: Domenico Ielo, Reggio Calabria (IT)

(72) Inventor: Domenico Ielo, Reggio Calabria (IT)

(21) Appl. No.: 16/062,607

(22) PCT Filed: Dec. 16, 2016
(86) PCT No.: PCT/IT2016/000293

§ 371 Date: Jun. 14, 2018

(30) Foreign Application Priority Data
Dec. 18, 2015 (IT) UB2015A009868

(51) Int. Cl. A01G 27/00; A01G 9/02; A01G 9/04; A01G 9/24

(52) U.S. Cl. CPC A01G 27/001; A01G 9/02; A01G 27/005; A01G 9/247; A01G 27/003; A01G 9/04

(57) ABSTRACT

An irrigation system with automatic irrigation liquid spraying device is described, comprising: a container (4), particularly for plants or flowers, the container being equipped with a perforated bottom; a bottom support (5) on which the perforated bottom of the container (4) is placed; at least one floater (3) equipped with at least one magnet (2) and placed in the support (5); at least one electromechanical reed-type device (1) operatively connected to the support (5) and adapted to be actuated by the at least one magnet (2) through a contact action of the reed blades driven by a magnetic field of the magnet (2); a tank (6) containing irrigation liquid; at least one pump (7) immersed in the tank (6), operatively connected to the container (4) on a side and to the electromechanical reed-type device (1) on another side.

### CROSS-REFERENCE TO RELATED APPLICATIONS

The present application is a national stage of International Patent Application No. PCT/IT2016/000293, titled “Irrigation System With Automatic Irrigation Liquid Spraying Device,” filed Dec. 16, 2016, which claims priority from Italian Patent Application No. UB2015A009868 filed Dec. 18, 2015, the contents of which are incorporated in this disclosure by reference in their entirety.

### BACKGROUND OF THE INVENTION

1) Field of the Invention

The present invention refers to an irrigation system with automatic irrigation liquid spraying device. The irrigation fluid is commonly water.

2) Background Art

The prior art as regards irrigation systems of this type is given by WO-A1-89/00809: this system has a container and an irrigating device, which prevent the operator from having to determine the irrigation times, and is the only system which does not need any timer, since the system itself is a direct sensor of thermal and hygrometric conditions and of the water-plant/flower absorption conditions. The system of WO-A1-80/00809 is an improvement with respect to irrigating systems which, in the majority of cases, provide the plant/flower container with a dropwise irrigation with an irrigation cycle set by a timer.

There are also a few irrigation systems without timer, which are mainly based on the capillary recall of water by using clay cones or by using multi-layer mats with a water reserve. Other systems use cords, which, being wetted by a water reserve, humidify the plant/flower container by capillarity. All the above systems, however, are “static” systems with a continuous water recall.

DE-A1-10 2008 016968 discloses another prior art irrigation system.

### SUMMARY OF THE INVENTION

Object of the present invention is solving the above prior-art problems, by providing an irrigation system with automatic irrigation liquid spraying device, which does without the presence of a timer, and automatically starts and stops the irrigation of liquid to the container for plants/flowers to which it is connected: this prevents the operator from having to continuously check the irrigation liquid level and provides irrigation only and when it is necessary, without any human intervention.

Another object of the present invention is providing an irrigation system as mentioned above, which has a simple structure, is easy to manufacture, has a small cost and is very efficient as regards its operation.

The above and other objects and advantages of the invention, as will appear from the following description, are obtained by an irrigation system with automatic irrigation liquid spraying device as claimed in claim 1. Preferred embodiments and non-trivial variations of the present invention are claimed in the dependent Claims.

It is intended that all enclosed claims are an integral part of the present disclosure.

### BRIEF DESCRIPTION OF THE DRAWINGS

The present invention will be better described by some preferred embodiments thereof, given as a non-limiting example, with reference to the enclosed drawings, in which:

FIG. 1 is a side sectional view of a first preferred embodiment of the irrigation system with automatic irrigation liquid spraying device of the present invention;

FIG. 2 is a side sectional view of a second preferred embodiment of the irrigation system with automatic irrigation liquid spraying device of the present invention; and

FIG. 3 is a side sectional view of a third preferred embodiment of the irrigation system with automatic irrigation liquid spraying device of the present invention.

### DETAILED DESCRIPTION OF PREFERRED EMBODIMENTS

With reference to the Figures, the irrigation system with automatic irrigation liquid spraying device of the invention substantially comprises:
a container 4, particularly for plants or flowers, the container being equipped with a perforated bottom, this perforated bottom allowing the excess irrigation liquid to be discharged from the container 4 after having irrigated the plant/flower contained therein;
a bottom support 5 on which the perforated bottom of the container 4 is placed;
at least one floater 3 equipped with at least one magnet 2 and placed in the support 5;
at least one electromechanical reed-type device 1 operatively connected to the support 5 and adapted to be actuated by the at least one magnet 2 through a contact action of the reed blades driven by a magnetic field of the magnet 2;
a tank 6 containing irrigation liquid;
at least one pump 7 immersed in the tank 6, operatively connected to the container 4 on a side and to the electromechanical reed-type device 1 on another side, the pump 7 being adapted to pump irrigation liquid from the tank 6 to the container 4 upon closing the reed blades with the magnet 2 when there is no irrigation liquid in the support 5 and the magnet 2 is in operating contact with the reed-type device 1, the pump 7 being adapted to stop pumping irrigation liquid from the tank 6 to the container 4 upon opening the reed blades when there is irrigation liquid in the support 5 so that the floater 3 with its magnet 2 moves away from its operating contact with the reed-type device 1.

Therefore, as can be seen above, the innovation given by the present invention is providing the bottom support 5 for the container 4 with the reed-type device 1 which operates as switch.

As known, the reed-type device 1 is an electro-mechanical component composed of two blades made of iron-nickel, which are mutually overlapped and separated by a few tenths of millimetre, sealed in a very small glass ampoule filled with inert gas: in its rest position, the reed-type device 1 is open and closed only when a magnetic field is present near its blades.

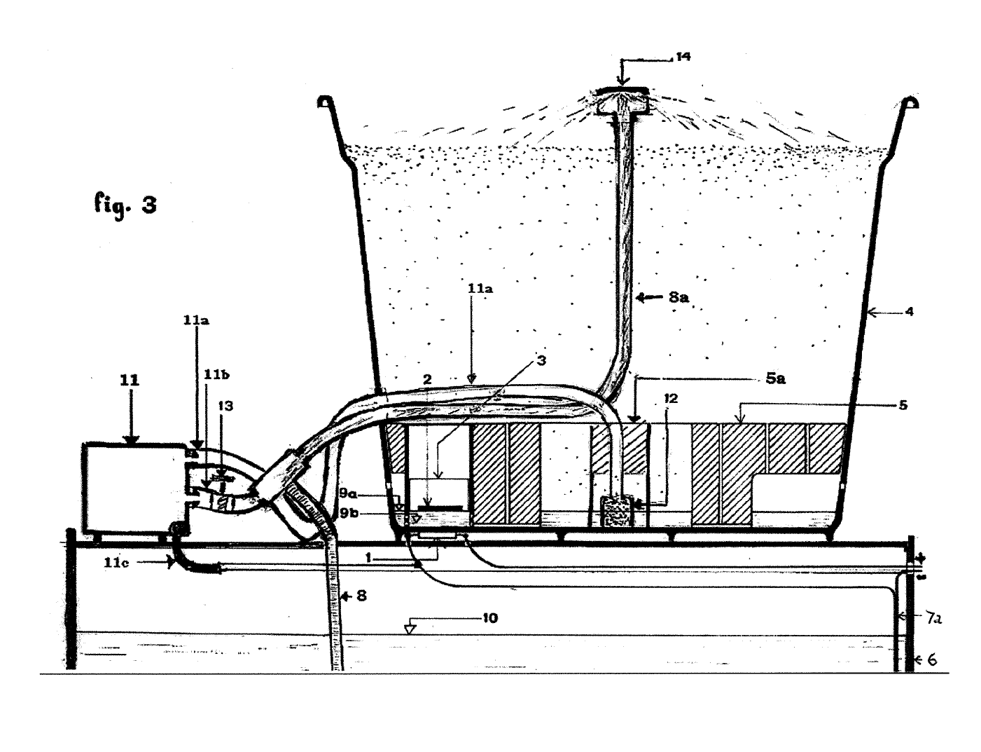

In the irrigation system of the present invention, this magnetic field is provided by the magnet 2 housed at the base of the floater 3, this latter one being constrained within its own guide: when the floater 3 descends from level 9a to the bottom level 9b of the support 5, it generates the contacts of the blades which, under the influence of the magnetic field, operate as opposite poles which attract themselves and close the circuit which allows actuating the immersion pump 7 to deliver irrigation fluid to the container 4 (through a shower element shown in the figures in different arrangements (for example 14 in FIG. 3).

The delivery of irrigation fluid ceases when the excess of irrigation water, by being collected on the bottom of the support 5, reaches level 9a, which, due to the floating thrust, will also be reached by the floater 3 and the magnet 2 connected therefor, which, not providing any more the magnetic field for polarizing the blades of the reed-type device 1, will go back to its open position, with the consequent interruption of the operation of the pump 7.

The level 9b of the bottom of the support 5 and the level 9a of the contact detachment can be regulated both depending on the intensity of the magnetic field of the magnet 2 fastened onto the base of the floater 3, and on the amount of draining water which has to be set. In practice, after experiments made by the Applicant, there is an oscillation of a few millimetres for plants needing a substrate with full water field capability, to an oscillation of 1 cm for plants which prefer a certain degree of “dryness”.

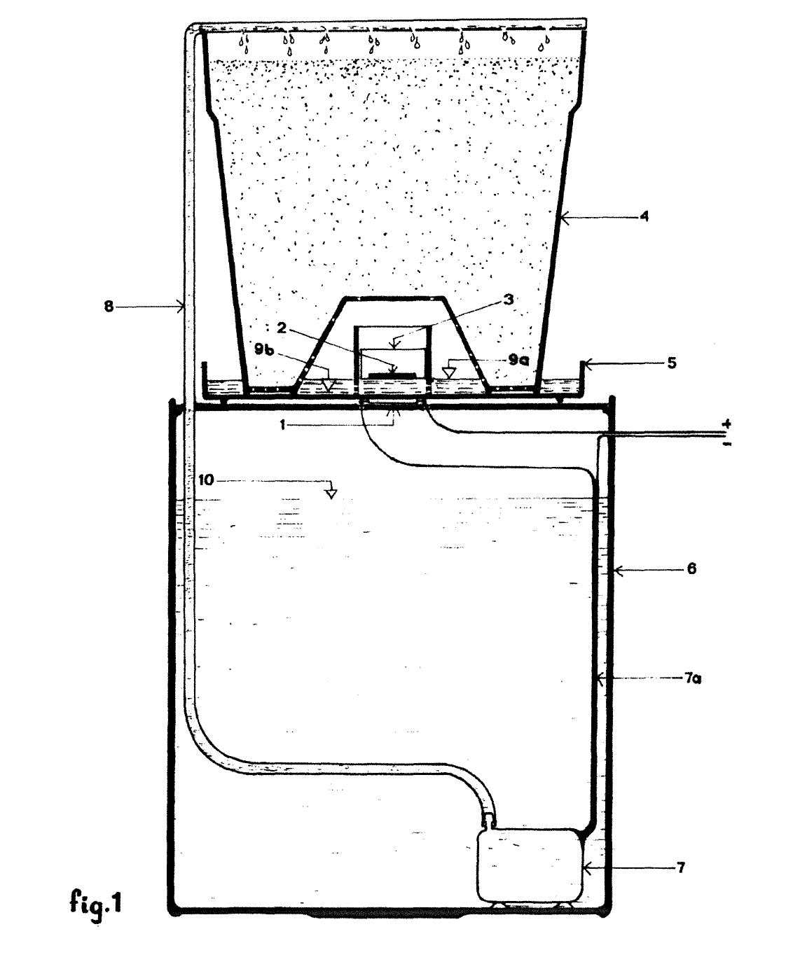

FIG. 1 shows the structural features of the draining air chamber of the container 4, in order to avoid the presence of a radical lack of air deriving from an uninterrupted capillary rise as occurs with plane contact surfaces: the crown of draining water, in this model with a water supporting plate 5, is external to the container 4 and is adapted for indoor applications.

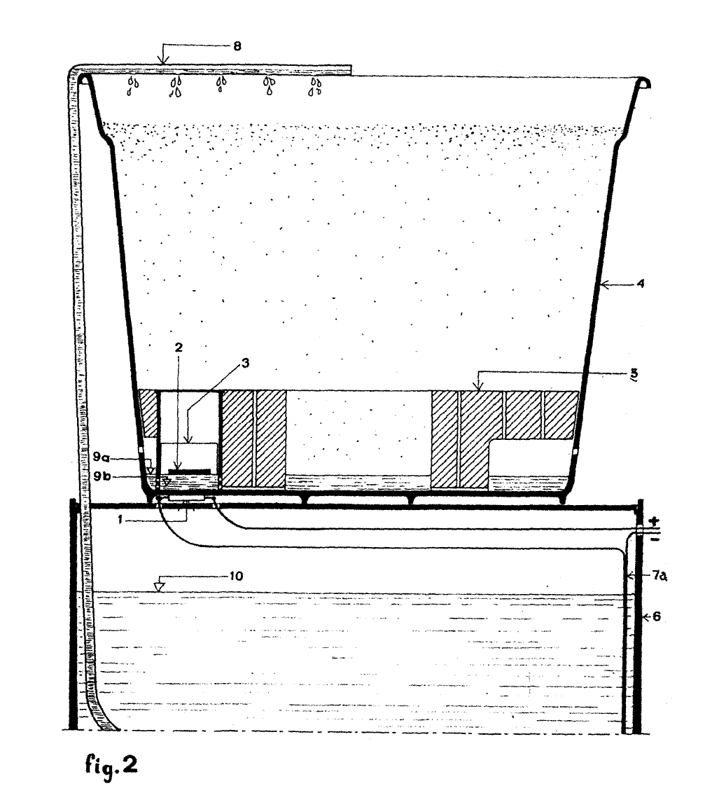

FIG. 2 shows an outdoor model, and adopts a draining bottom support 5 made of foamed polystyrene: in this case, the crown of draining water is inside, while the contact area of the plant radical apparatus is limited to the central part of the container 4. Such solution is suitable for outdoor use, since it avoids too quick an evaporation of the crown of draining water due to insulation.

In FIGS. 1 and 2, reference number 7a designates an electric wire for the pump 7; 8 designates a small pipe for passing liquid; and 10 designates the irrigation liquid level.

FIG. 3 shows a model in which the concept of draining air chamber is better developed, and in which a spray irrigation with forced air is adopted, which allows a better irrigation uniformity with respect to the drop-type irrigation adopted in the systems of FIGS. 1 and 2.

In this case, a small air pump 11 is used, which serves both to enter air from the bottom trap 5a of the support 5 and to force water into a water passing tube 8a coming from the immersion pump 7, while the opening-closing mechanism with magnet 2 and reed blades remains unchanged.

With closed circuit, water coming from the immersion pump 7 is dragged by air coming from the air pump 11, in a laminar mode, and the acquisition of some kinetic energy allows creating a spray-type delivering device 14 when water, upon exiting, strikes a surface, preferably a plane surface, on which it flows, the delivering device 14 being activated by entering air in the duct of liquid coming from the immersion pump 7.

In FIG. 3, reference number 11c designates an electric wire for actuating the air pump 11.

The advantages provided by such solution are:
maximum and optimum oxigenation of the delivered irrigation liquid;
modulation of the delivery through a tap 13 for regulating the air flow-rate and the delivered liquid;
chance of delivering water at a greater height than the flow-rate height of the used immersion pump. In practice, with the adoption of a 2-3 Watt air pump, it is possible to deliver the water flow at a height over 100 cm with respect to a 3-5 Watt immersion pump with a flow-rate height not greater than 45 cm.

The air pump 11 has two ways, 11a, 11b, since an outlet way 11a will perform the above described object, while the other way 11b will be used to enter air in the bottom trap 5a having a porous stone 12: in this way, the radical plant system will use an air cushion upon its maximum watering due to the current irrigation. In the Applicant's experiments, the adopted solution has proven useful for plants which remain for a long time in the container 4 with the same substrate, which is unavoidably subjected to a certain compaction due to the modification of its solid-liquid-air balance.

1. An irrigation system with automatic irrigation liquid spraying device, comprising:
a container, particularly for plants or flowers, the container being equipped with a perforated bottom;
a bottom support on which the perforated bottom of the container is placed;
at least one floater equipped with at least one magnet and placed in the support;
at least one electromechanical reed-type device operatively connected to the support and adapted to be actuated by the at least one magnet through a contact action of the reed blades driven by a magnetic field of the magnet;
a tank containing irrigation liquid;
at least one pump immersed in the tank, operatively connected to the container on a side and to the electromechanical reed-type device on another side, the pump being adapted to pump irrigation liquid from the tank to the container upon closing the reed blades with the magnet when there is no irrigation liquid in the support and the magnet is in operating contact with the reed-type device, the pump being adapted to stop pumping irrigation liquid from the tank to the container upon opening the reed blades when there is irrigation liquid in the support so that the floater with its magnet moves away from its operating contact with the reed-type device; and
at least one small air pump, which serves both to enter air from a bottom trap of the support and to force water coming from the immersion pump into a water passing tube, with a closed circuit, water coming from the immersion pump being thereby dragged by air coming from the air pump, and the acquisition of some kinetic energy allows creating a spray-type delivering device when water, upon exiting, strikes a surface on which it flows, the delivering device being activated by entering air in the duct of liquid coming from the immersion pump.

2. (canceled)

3. The irrigation system of claim 1, wherein the air pump has two ways, an outlet way and another way to enter air in the bottom trap having a porous stone, the radical plant system thereby using an air cushion upon its maximum watering due to the current irrigation.

4. The irrigation system of claim 1 further comprising a tap for regulating the air flow-rate and the delivered liquid.

5. The irrigation system of claim 1, wherein the bottom support is made of foamed polystyrene.
